(19) United States
(12) Patent Application Publication
(10) Pub. No.: US 2009/0300878 A1
(43) Pub. Date: Dec. 10, 2009

(54) ORIGINAL COVER CLOSER AND OFFICE EQUIPMENT

(76) Inventor: Naokazu SUZUKI, Yokohama (JP)

Correspondence Address: NOTARO & MICHALOS P.C., 100 DUTCH HILL ROAD, SUITE 110, ORANGEBURG, NY, 10962-2100, US

(21) Appl. No.: 12/469,889

(22) Filed: May 21, 2009

(30) Foreign Application Priority Data
Jun. 5, 2008 (JP) 2008-147819

(51) Int. Cl. E05F 1/00

(52) U.S. Cl. 16/71

(57) ABSTRACT

In order to provide an original cover closer capable of realizing not only a miniaturization of a driving part but also a low cost and an office equipment provided with the original cover closer, a closer automatically and manually supporting the original cover in an openable/closable manner with respect to a main body of the office equipment is composed of a hinge part and the driving part, in which the hinge part supports a rear portion of the original cover at a backward side of the main body and supports the original cover in an openable/closable manner with respect to the main body, and the driving part is formed of a drive arm that supports either or both left and right side portions of the original cover at a forward side of the hinge part of the main body, a driving force transmitting means that transmits a driving force to the drive arm, and a drive motor that applies the driving force to the driving force transmitting means.

### BACKGROUND OF THE INVENTION

1. Field of the Invention

The present invention relates to an original cover closer suitable for use in an office equipment such as a copying machine, a printer, a facsimile machine, a scanner, and so on, and the office equipment provided with the original cover closer.

2. Description of the Related Art

A main body of an office equipment such as a copying machine, a printer, a facsimile machine, a scanner, and so on has an original cover rotatably attached to an upper surface of the main body via an original cover closer. The original cover closer can pivotally support the original cover in a rotatable manner to cover over a contact glass being the upper surface of the main body with the original cover and expose the contact glass. When the office equipment is not used, the original cover is normally closed by being appressed against on the contact glass being the upper surface of the main body. In order to set an original on the contact glass without using an automatic original feeder, there is a need to open the original cover to expose (open) the contact glass, and after the original is placed on an exposed surface of the contact glass, the original cover is closed and then the original is press-contacted against on the contact glass by the original cover.

As described above, in almost all cases, the operation of original cover is generally performed manually. The manual operation of the original cover may be hard especially for elderly people, people in wheel chairs, and other handicapped people, and further, in order to set an original held by both hands, sometimes there is a need to put down the original once to open the original cover. Accordingly, there has been proposed an original cover closer provided with a function of automatically rotating the original cover. As a publicly known document disclosing such an original cover closer, one described in Japanese Patent Laid-open No. 2008-63785 is publicly known.

The original cover closer is provided with a hinge part that rotatably supports the original cover with respect to a main body of an office equipment, and a driving part that automatically drives the hinge part. The driving part includes a drive motor, and a driving force transmitting mechanism that decelerates a rotary driving force of this drive motor and transmits the force to a rotary shaft, in which the rotary driving force of the drive motor is transmitted to a supporting member via the rotary shaft, which enables an automatic opening/closing of the original cover.

In the original cover closer disclosed in the publication of unexamined patent application, the rotary driving force of the drive motor is transmitted to the rotary shaft by connecting the driving force transmitting mechanism and the rotary shaft, which realizes the automatic opening/closing of the original cover. However, since the rotary shaft supports the original cover in an openable/closable manner, in order to open/close the original cover by rotating the rotary shaft, a large amount of force is required. For this reason, a high-power motor has to be used as the drive motor, which makes the driving part large in size and also makes the cost high.

### SUMMARY OF THE INVENTION

The present invention has been made to solve the above-stated problems and an object thereof is to provide an original cover closer capable of realizing not only a miniaturization of a driving part but also a low cost, and an office equipment provided with the original cover closer.

To achieve the above object, an original cover closer according to the present invention being a closer automatically and manually supporting an original cover in an openable/closable manner with respect to a main body of an office equipment is characterized in that it is composed of a hinge part and a driving part, in which the hinge part supports a rear portion of the original cover at a backward side of the main body and supports the original cover in an openable/closable manner with respect to the main body, and the driving part is formed of a drive arm that supports either or both left and right side portions of the original cover at a forward side of the hinge part of the main body, a driving force transmitting means that transmits a driving force to the drive arm, and a drive motor that applies the driving force to the driving force transmitting means.

According to the present invention, since the driving part is formed of the drive arm that supports either of left and right side portions of the original cover at the forward side of the hinge part of the main body, the driving force transmitting means that transmits the driving force to the drive arm, and the drive motor provided in the driving force transmitting means, a portion at which a force is acted on the original cover when opening/closing the original cover is distant from the hinge part. Accordingly, it is possible to open/close the original cover with a small amount of force compared to a case in which the force is acted on the hinge part, and thus there is no need to use a high-power motor as the drive motor. As a result, it becomes possible to realize not only the miniaturization of the driving part but also the low cost.

In the original cover closer according to the present invention, it is preferable that the hinge part is provided with a lift mechanism. Further, in the original cover closer according to the present invention, it is preferable that the drive arm is a raising/lowering arm. Further, in the original cover closer according to the present invention, it is preferable that the raising/lowering arm includes rack teeth engaging with a pinion attached to a drive case, and is structured to be sandwiched between a pair of guide members in a slidable manner in a state in which a movement thereof in the left and right directions of the main body when the main body is seen from the front, is controlled. Further, in the original cover closer according to the present invention, it is preferable that the drive case is attached to the main body in a swingable manner in the raising/lowering direction of the raising/lowering arm. Further, in the original cover closer according to the present invention, it is preferable that the drive arm is rotatably attached to a holding means whose one end portion is detachably attached to one side portion of the original cover. Further, in the original cover closer according to the present invention, it is preferable that the drive arm is a rotary arm. Further, in the original cover closer according to the present invention, it is preferable that one end portion of the rotary arm is slidably engaged with a guide groove formed in the original cover.

Further, in the original cover closer according to the present invention, it is preferable that the lift mechanism of the hinge part includes a lifting member that supports the original cover by being rotatably attached to a free end portion side of a supporting member rotatably attached to a mounting member attached to the main body side. Further, in the original cover closer according to the present invention, it is preferable that the lift mechanism of the hinge part includes a leg portion attached to a mounting member attached on the main body so that it can move vertically with respect to the main body. Further, in the original cover closer according to the present invention, it is preferable that the driving force transmitting means is provided with a clutch means that releases a connection between the driving force transmitting means and the drive arm when the original cover is operated manually. Further, in the original cover closer according to the present invention, it is preferable that the driving part is placed on a stand which is provided separately from the main body. Further, in the original cover closer according to the present invention, it is preferable that the stand is provided on a mounting plate which is fixed by mounting the main body thereon. Further, in the original cover closer according to the present invention, it is preferable that the drive case to which the drive arm is attached is placed inside the main body, and the drive arm is structured to be protruded above the main body via a guide groove formed on the main body.

Further, to achieve the above object, an office equipment according to the present invention is characterized in that it includes the aforementioned original cover closer according to the present invention. According to this invention, the driving part is formed of the drive arm that supports either of left and right side portions of the original cover at the forward side of the hinge part of the main body, the driving force transmitting means that transmits the driving force to the drive arm, and the drive motor provided in the driving force transmitting means, similarly as described above, so that it is possible to open/close the original cover with a small amount of force and to realize not only the miniaturization of the driving part but also the low cost.

As described above, in the original cover closer and the office equipment according to the present invention, the driving part is formed of the drive arm that supports either of left and right side portions of the original cover at the forward side of the hinge part of the main body, the driving force transmitting means that transmits the driving force to the drive arm, and the drive motor provided in the driving force transmitting means, so that it is possible to open/close the original cover with a small amount of force, and to realize not only the miniaturization of the driving part but also the low cost.

### BRIEF DESCRIPTION OF THE DRAWINGS

FIG. 1 is a schematic perspective view showing an example of an office equipment provided with a first original cover closer according to the present invention;

FIGS. 2A and 2B are schematic side views showing an example of the first original cover closer according to the present invention, in which FIG. 2A is a view showing an open state, and FIG. 2B is a view showing a state in which the original cover is closed and a height thereof becomes maximum;

FIG. 3 is a perspective view showing an example of a tip portion of a raising/lowering arm according to the present invention;

FIG. 4 is a perspective view showing an example of a driving force transmitting means according to the present invention;

FIG. 5 is a plan view showing an example of the driving force transmitting means according to the present invention;

FIG. 6 is a front view showing an example of the driving force transmitting means according to the present invention;

FIG. 7 is an exploded perspective view showing an example of the driving force transmitting means according to the present invention;

FIG. 8 is a sectional side view showing an example of a hinge part according to the present invention and showing a state in which the original cover is closed;

FIG. 9 is a sectional side view showing an example of the hinge part according to the present invention and showing a state in which the original cover is opened;

FIGS. 10A and 10B are views showing an example of a clutch means according to the present invention, in which FIG. 10A is its plan view, and FIG. 10B is a rear view of a part of an electromagnetic clutch;

FIG. 11 is a schematic perspective view showing another example of the office equipment provided with the first original cover closer according to the present invention;

FIG. 12 is a schematic perspective view showing another example of the office equipment provided with the first original cover closer according to the present invention;

FIGS. 13A and 13B are schematic views showing an example of an office equipment provided with a second original cover closer according to the present invention, in which FIG. 13A is a perspective view and FIG. 13B is a front view;

FIG. 14 is a perspective view showing another example of the tip portion of the raising/lowering arm according to the present invention;

FIG. 15 is a schematic perspective view showing an example of an office equipment provided with a third original cover closer according to the present invention and showing a state in which the original cover is opened;

FIG. 16 is a schematic perspective view showing an example of the office equipment provided with the third original cover closer according to the present invention and showing a state in which the original cover is closed;

FIG. 17 is a perspective view showing an example of a tip portion of a rotary arm according to the present invention;

FIG. 18 is a perspective view showing an example of a rotation driving means according to the present invention;

FIG. 19 is a plan view showing an example of the rotation driving means according to the present invention;

FIG. 20 is a front view showing an example of the rotation driving means according to the present invention; and

FIG. 21 is an exploded perspective view showing an example of the rotation driving means according to the present invention.

### DETAILED DESCRIPTION OF THE PREFERRED EMBODIMENT(S)

Hereinafter, an original cover closer and an office equipment according to the present invention will be described in detail based on the accompanying drawings.

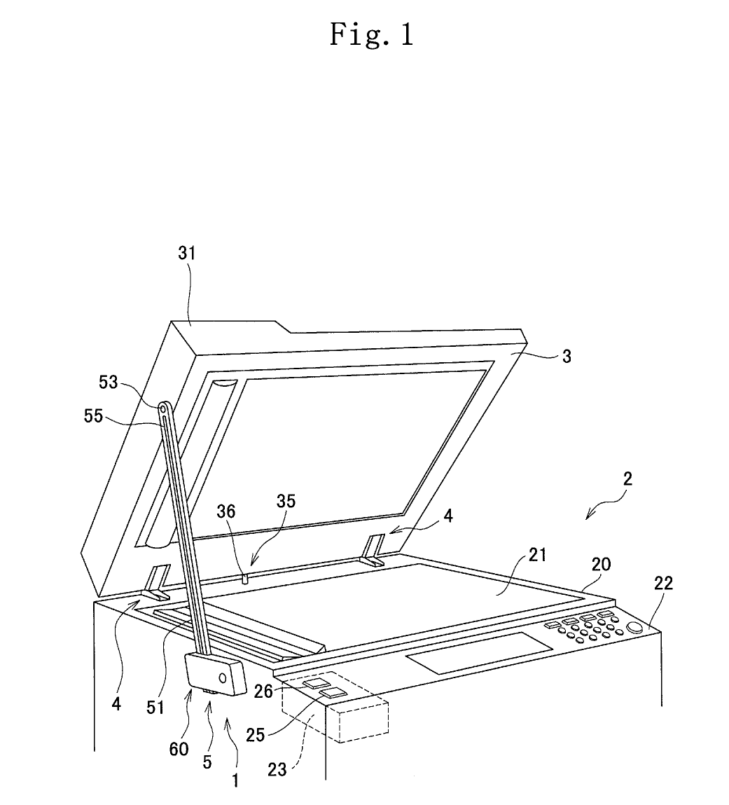

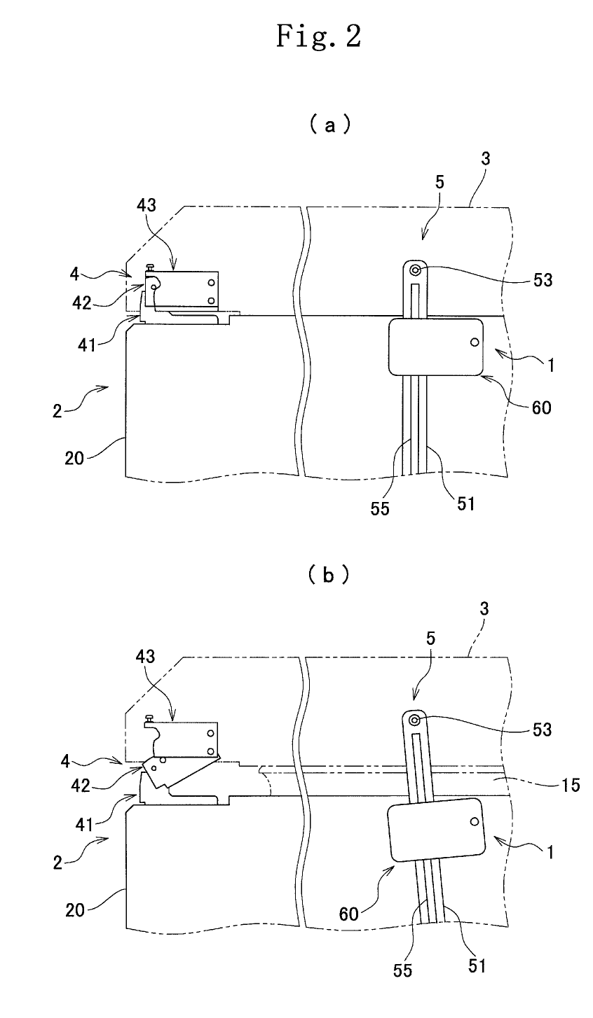

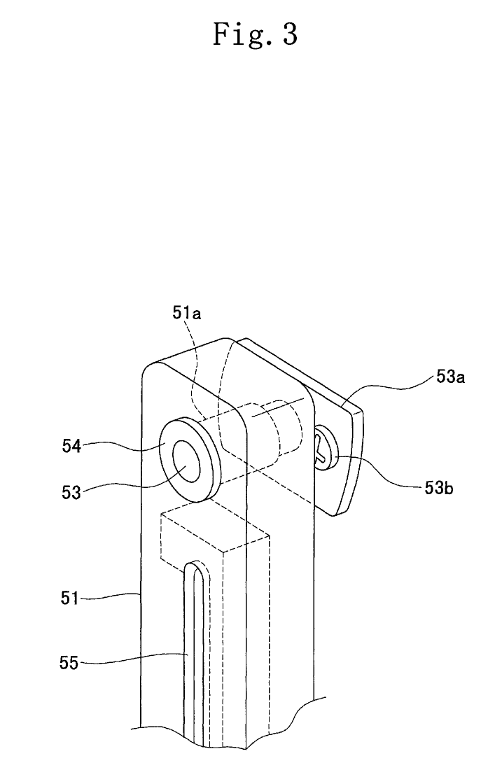

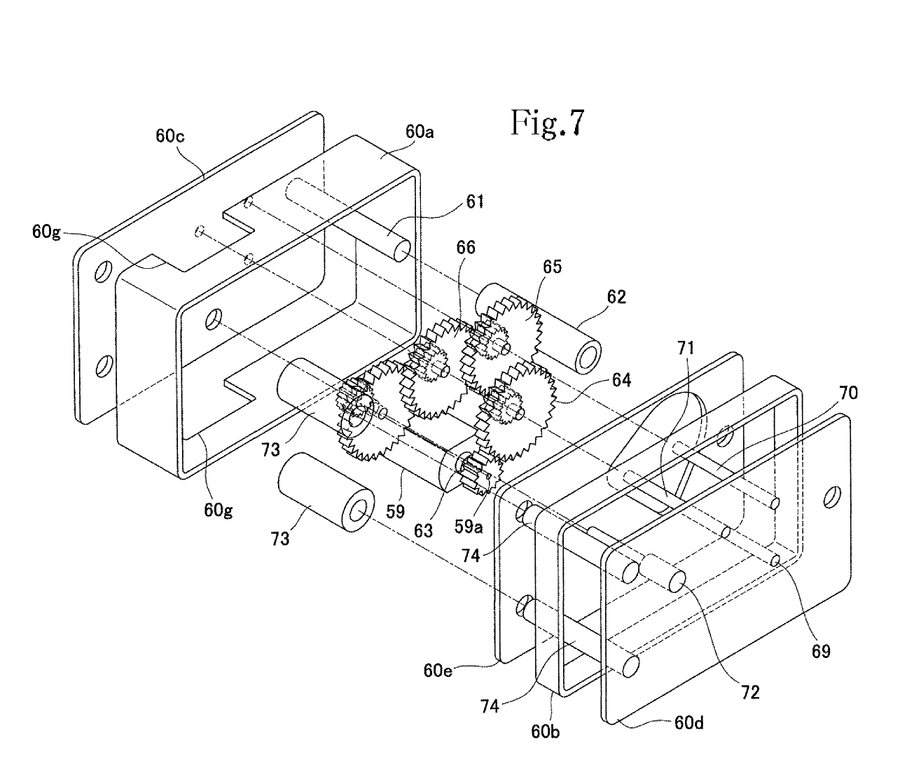

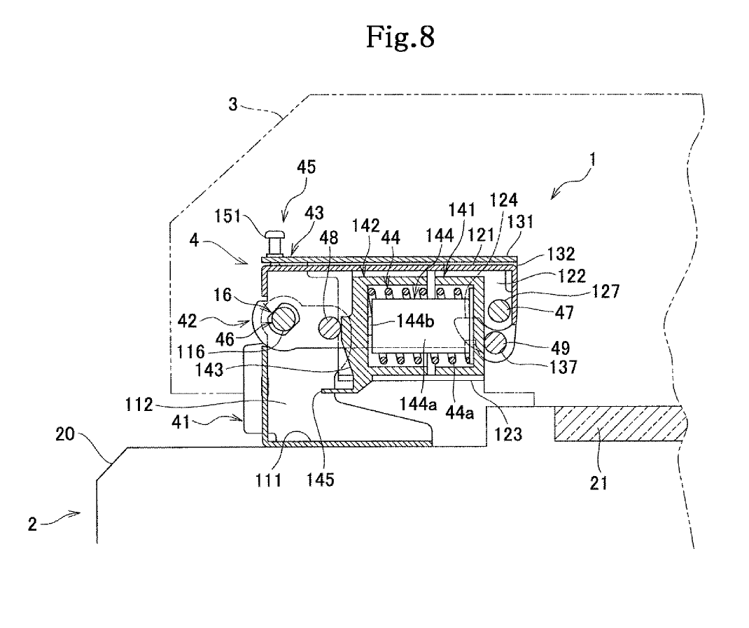

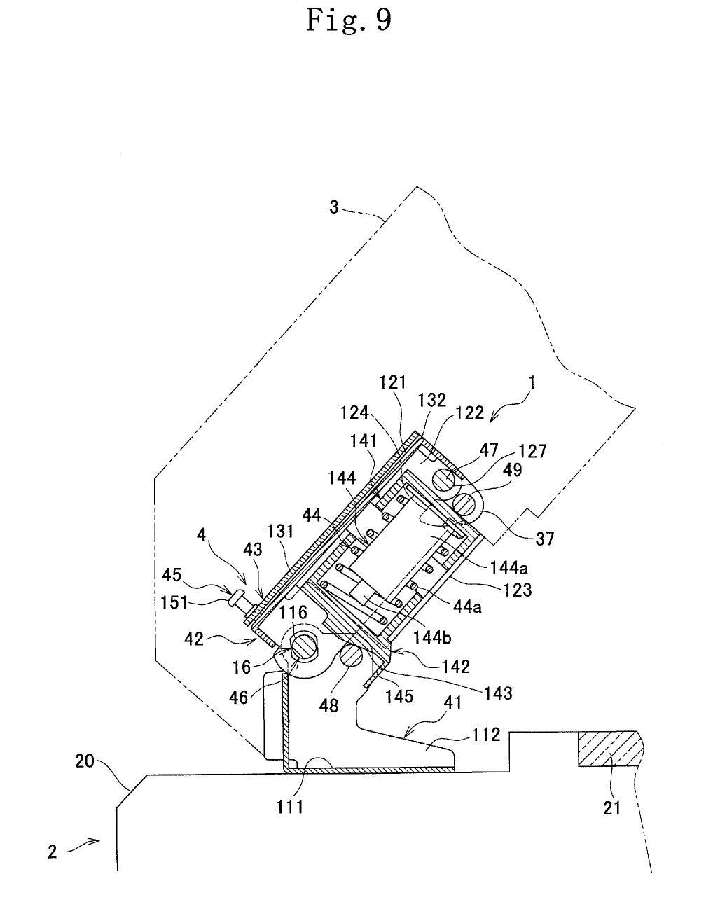

FIG. 1 is a view showing an example of an office equipment provided with a first original cover closer according to the present invention. FIGS. 2A and 2B are views showing an example of the first original cover closer according to the present invention. FIG. 3 to FIG. 7 are views showing an example of a driving part according to the present invention. FIG. 8 and FIG. 9 are views showing an example of a hinge part according to the present invention. As shown in FIG. 1 and FIGS. 2A and 2B, the first original cover closer according to the present invention includes a hinge part 4 that supports an original cover 3 in an openable/closable manner with respect to a main body 20 of an office equipment 2 and a driving part 5 that makes the original cover 3 automatically perform an opening/closing operation, and it can open/close the original cover 3 automatically and manually. The office equipment 2 is not limited in particular, and, for instance, a copying machine, a printer, a facsimile machine, a scanner and so on can be cited as a usable office equipment, and, in particular, a copying machine is preferable as the office equipment 2. The original cover 3 is provided with, for instance, an original automatic feeder 31.

The hinge part 4 generally referred to as an original cover closer supports the original cover 3 in an openable/closable manner with respect to the main body 20 of the office equipment 2, and usually supports the original cover 3 with two hinge parts 4. The two hinge parts 4 may be the same or different ones as long as they can support the original cover 3 in an openable/closable manner with respect to the main body 20. In an example shown in FIG. 1, an example in which the same hinge parts are used as the two hinge parts 4 to support the original cover 3 in an openable/closable manner with respect to the main body 20 is described.

As shown in FIG. 8 and FIG. 9, the hinge part 4 includes: a mounting member 41 attached to the main body 20; a supporting member 42 axially supported to the mounting member 41 in a rotatable manner together with a rotary shaft 46 via the rotary shaft 46; a lifting member 43 overlapped with the supporting member 42, axially supported to a free end portion of the supporting member 42 in a rotatable manner, and attached to the original cover 3; and a resilient means 44 disposed between the mounting member 41 and the supporting member 42, rotatably urging the original cover 3 in an opening direction, and urging the lifting member 43 in a direction in which the lifting member 43 overlaps with the supporting member 42, for instance. Note that the opening direction in the present invention indicates a direction in which the original cover 3 is leaving from a contact glass 21 when the original cover 3 is rotated via the hinge part 4. Further, a closing direction in the present invention indicates a direction being the opposite direction to the opening direction, namely, a direction in which the original cover 3 comes close to the contact glass 21 when the original cover 3 is rotated via the hinge part 4.

The mounting member 41 is mainly formed of a bottom plate 111 detachably attached to the main body 20, and both side plates 112 respectively extending from both side end portions of the bottom plate 111 in a direction perpendicular (including a direction substantially perpendicular) to the bottom plate 111, and opposing to each other. The bottom plate 111 is formed in a substantially rectangular shape and is provided with a mounting hole (not shown) with which the bottom plate 111 is attached to the main body 20 with a machine screw or the like. The side plate 112 is formed in a substantially L-shape with the bottom plate 111, and a shaft hole 116 into which the rotary shaft 46 is inserted via a bearing (not shown) is provided on a tip portion (upper portion) thereof. Namely, the bearing is attached to the shaft hole 116, and the rotary shaft 46 is inserted into the bearing. The side plate 112 is provided with a fixing pin hole (not shown) at a position on the bottom plate 111 side (downward) of the shaft hole 116 of the side plate 112 and shifted inward (frontward). Fixing pins 48 are inserted into the fixing pin holes of both the side plates 112. The fixing pin 48 is a pressure bearing member with which a first end portion of the later-described resilient means 44, that is, an outer surface of a bottom portion of a later-described second slider 142 comes into contact, and the pressure bearing member is not limited to a pin such as the fixing pin 48, and may be a roller, for example, a pressure bearing roller or the like.

The supporting member 42 is formed of a top plate 121 having a rectangular flat plate shape, both side plates 122 respectively extending from both side end portions of the top plate 121 in a downward direction perpendicular (including a direction substantially perpendicular) to the top plate 121 and opposing to each other, and guide plates 123 formed by bending tip portions of the side plates 122 into 90° in the direction opposing to each other. One end portions (tip portions) of both the side plates 122 are provided with hinge pin holes 127 into which a hinge pin 47 is inserted, and are provided with notched portions 124 into which an operation pin 49 is fit. The other end portions (rear end portions) of both the side plates 122 are respectively provided with shaft insertion holes (not shown) into which the rotary shaft 46 is inserted. By aligning these shaft insertion holes and the shaft hole 116 of the mounting member 41 and inserting the rotary shaft 46 into these holes, the supporting member 42 is supported in a rotatable manner with respect to the mounting member 41.

The lifting member 43 constitutes the lift mechanism. Note that the lift mechanism may be provided or not, but is preferably provided. The lifting member 43 is formed in a substantially U-shape with a top plate 131 having a substantially rectangular flat plate shape detachably attached to a rear end side of the original cover 3 using a machine screw or the like, and both side plates 132 respectively extending from both end portions of the top plate 131 in a downward direction perpendicular (including a direction substantially perpendicular) to the top plate 131 and opposing to each other, so as to cover the supporting member 42. A flange (not shown) having a mounting hole (not shown) for attaching the lifting member 43 to the original cover 3 is provided to each of both the side plates 132.

A hinge pin insertion hole (not shown) is provided at a portion in the vicinity of one end portion (tip portion) of the side plate 132 and on the top plate 131 side, and an operation pin hole 137 into which the operation pin 49 is inserted is provided at a lower side of the hinge pin insertion hole. The operation pin 49 is inserted into the operation pin holes 137 of both the side plates 132 and fixed. The hinge pin insertion holes (not shown) of both the side plates 132 and the hinge pin holes 127 of both the side plates 122, 122 of the supporting member 42 are aligned, and the hinge pin 47 is inserted into these holes, thereby rotatably connecting the lifting member 43 and the supporting member 42 using the hinge pin 47 as a shaft.

Further, it is preferable that a horizontal position adjusting means 45 that adjusts a horizontal position of the original cover 3 is provided in the vicinity of a rear end portion of the top plate 131. The horizontal position control means 45 is formed of an adjustment screw 151 provided, for instance, in the vicinity of the rear end portion of the top plate 131 and on a central portion (including a substantially central portion) in a cross direction of the top plate 131. A tip of the adjustment screw 151 comes into contact with the top plate 121 of the supporting member 42 so that a distance between the supporting member 42 and the lifting member 43 is adjusted by the adjustment of the adjustment screw 151, thereby adjusting the horizontal position of the original cover 3. Note that it is preferable to attach a not-shown adjusting nut for preventing a loosening to the adjustment screw.

The resilient means 44 rotatably urges the original cover 3 in the opening direction and urges the lifting member 43 in the direction in which the lifting member 43 overlaps with the supporting member 42, in which when the original cover 3 is positioned at an angle equal to or less a predetermined opening angle, an urging force to urge the original cover 3 is smaller than a moment of the original cover 3. The resilient means 44 includes, for instance, a pair of sliders 141, 142 fitted into the supporting member 42 and a compression spring 44a provided in the pair of sliders 141, 142. Note that the opening angle in the present invention is an angle of the original cover 3 with respect to a surface of the contact glass 21 being an upper surface of the main body 20. The predetermined opening angle in the present invention is, for instance, an angle at which the urging force to urge the original cover 3 with the resilient means 44 becomes smaller than the moment of the original cover 3.

The pair of sliders 141, 142 are formed in a shape of bottomed cylinder having a rectangular cross section. The pair of sliders 141, 142 are respectively and individually fitted in the supporting member 42 in a slidable manner with their opening portions opposed to each other, and the compression spring 44a is installed in the pair of sliders 141, 142. The pair of sliders 141, 142 are formed in a length to be fitted in the supporting member 42 when the bottom plate 111 of the mounting member 41 and the supporting member 42 (top plate 121) are substantially in parallel (for instance, when the original cover 3 is appressed against on the contact glass 21 being the upper surface of the main body 20 (when the original cover is appressed)).

The number of the compression springs 44a is not limited in particular, and may be one, two or more, and for instance, one spring is provided to urge the pair of sliders 141, 142 in a direction in which they separate from each other. The compression spring 44a rotatably urges the original cover 3 in the opening direction, and when the original cover 3 is positioned at an angle equal to or less the predetermined opening angle (for instance, 20° (including around 20°)), the urging force urging the original cover 3 is smaller than the moment of the original cover 3.

A closed surface being an outer surface of a bottom portion of the slider (which may be referred to as a first slider 141) on the tip portion side presses the operation pin 49 with the urging force of the compression spring 44a, which makes the supporting member 42 and the lifting member 43 overlap with each other. Specifically, the tip of the adjustment screw 151 of the top plate 131 of the lifting member 43 comes into contact with the top plate 121 of the supporting member 42 with the urging force of the compression spring 44a, and the top plate 121 of the supporting member 42 and the top plate 131 of the lifting member 43 are overlapped or substantially overlapped with each other.

An inclined portion 143 is provided on an outer surface of a bottom portion of the slider (second slider 142) on the rear end portion side. The inclined portion 143 is a spot that comes into contact with the fixing pin 48. Specifically, when the original cover 3 is rotated in the opening direction via the rotary shaft 46 from a state in which the original cover 3 is appressed against the contact glass 21 being the upper surface of the main body 20, namely a state in which the original cover 3 is in a closed position (refer to FIG. 8), the spot that comes into contact with the fixing pin 48 slides along the inclined portion 143, and the second slider 142 is pressed to slide toward the rear end portion side inside the supporting member 42 by the compression spring 44a, resulting that the compression spring 44a gradually extends. Further, when the original cover 3 reaches a maximum usable opening angle, the rotation thereof is controlled by an original cover rotation controlling mechanism (not shown). Note that a reference numeral 145 in FIG. 8 and FIG. 9 denotes an extended piece. Accordingly, even when a lubricating grease to smooth the slide of the second slider 142 is applied to an outer surface of the fixing pin 48, since the extended piece 145 covers a large part of an outer periphery of the fixing pin 48, if an end portion of an original deformed by being pressed by the original cover 3 is protruded toward the fixing pin 48 side, there is no chance that the end portion is stained by being brought into contact with the fixing pin 48 to which the grease is applied. The extended piece 145 is preferably formed in a width of a size slightly shorter than a width of the second slider 142, for instance.

The maximum usable opening angle in the present invention is an angle of the original cover 3 with respect to the surface of the contact glass 21 being the upper surface of the main body 20, and an angle at which the rotation of the original cover 3 in the opening direction is controlled. This maximum usable opening angle is not limited in particular, but is preferably from, for example, 60° (including around 60°) to 70° (including around 70°), and is 70° (including around 70°), for instance.

Further, it is also possible that a fluid damper device 144 or a spring damper is provided in the aforementioned compression spring 44a. The fluid damper device 144 operates, only when the original cover 3 is rotated in the closing direction and is positioned at an angle equal to or less than the predetermined opening angle (for instance, equal to or less than 10° or so) of the original cover 3, to reduce a rotating speed of the original cover 3. The fluid damper device 144 is, for instance, an oil damper device or the like. The fluid damper device 144 may also be attached in the opposite direction to that of the embodiment, namely, it may be attached by directing a cylinder 144a portion toward the second slider 142 side and directing a piston 144b side toward the first slider 141 side.

The driving part 5 makes the original cover 3 supported in an openable/closable manner with respect to the main body 20 of the office equipment 2 via the hinge part 4 automatically perform an opening/closing operation The driving part 5 is provided, for instance, on a side surface of the main body 20 on the side in which a center of gravity of the original cover 3 is inclined because of the attachment of the original automatic feeder 31. Note that the driving part 5 may also be provided on the remaining side surface of the main body 20. The driving part 5 is formed of a drive arm that supports a side surface of the original cover 3 on the forward side of the hinge part 4 of the office equipment 2, a driving force transmitting means 52 that transmits a driving force to the drive arm, and a drive motor provided in the driving force transmitting means 52.

As shown in FIG. 1 to FIG. 4, the drive arm is a raising/lowering arm 51 formed in a long bar shape having a rectangular cross section. One end portion to be an upper end portion of the raising/lowering arm 51 is rotatably attached to one side surface of the original cover 3 on a slightly forward side of a substantially central portion thereof. On the slightly forward side of the substantially central portion of the one side surface of the original cover 3, a rotary support shaft 53 is attached by being protruded in a cross direction of the original cover 3. The rotary support shaft 53 protrudes, for instance, to a mounting piece 53a having a substantially rectangular flat plate shape, and the mounting piece 53a is attached to the side surface of the original cover 3 using, for instance, a machine screw 53b or the like, (refer to FIG. 3), to thereby attach the rotary support shaft 53 in a protruding manner in the cross direction of the original cover 3. The one end portion of the raising/lowering arm 51 is provided with a through hole 51a, and when the rotary shaft 46 is inserted into the through hole 51a via a guide member 54, the raising/lowering arm 51 is rotatably attached to the one side surface of the original cover 3.

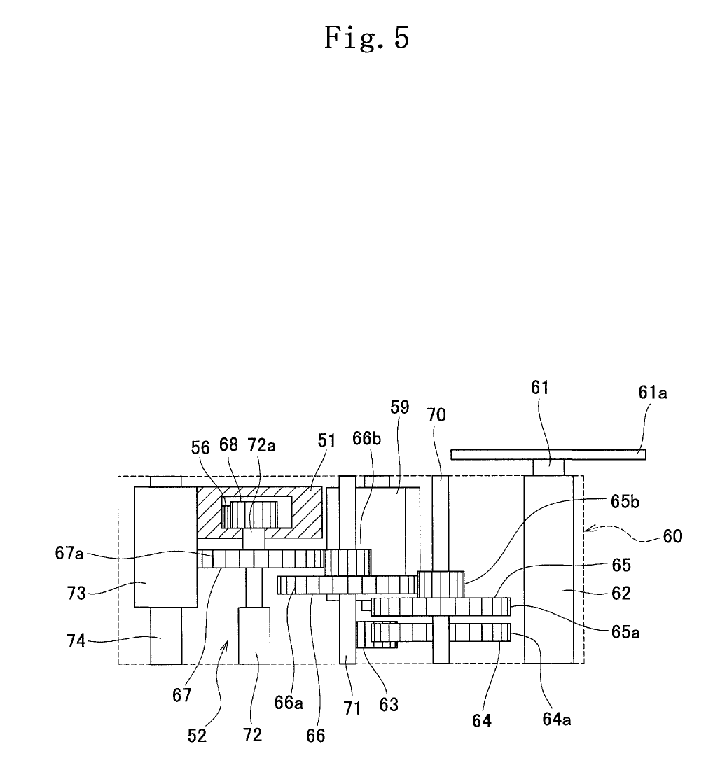

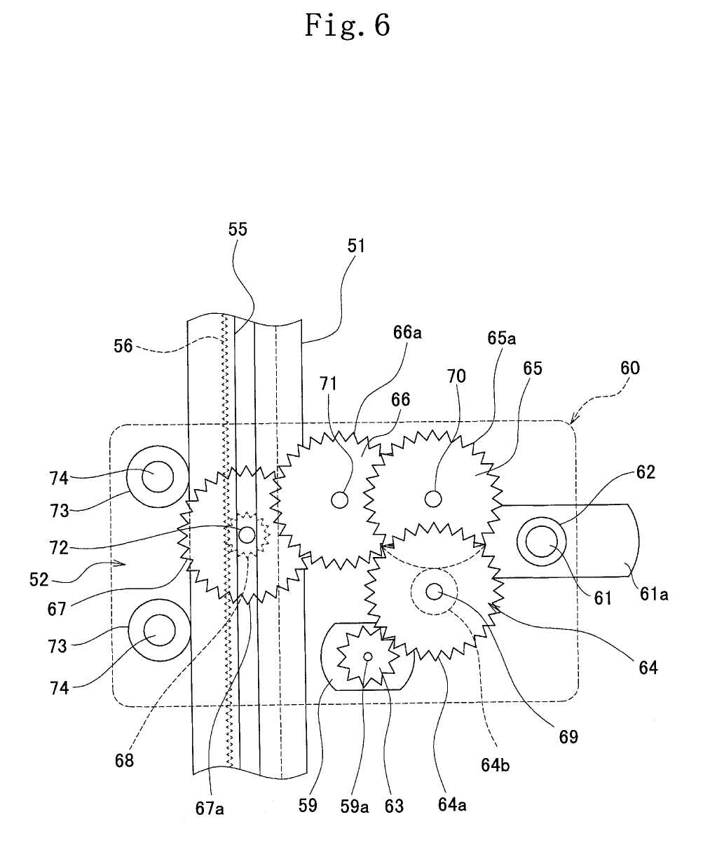

Further, as shown in FIG. 1 to FIG. 6, on a surface of the raising/lowering arm 51 being the opposite side of the original cover 3 and the main body 20, a recessed portion 55 extending in a longitudinal direction thereof is provided. An inside of the recessed portion 55 is formed as an engaging portion whose width is larger than a width of an opening portion. A large number of teeth are linearly provided in a longitudinal direction on an inner surface of the engaging portion on the hinge part 4 side, and are formed as rack teeth 56 (refer to FIG. 5 and FIG. 6).

The driving force transmitting means 52 transmitting the driving force to the raising/lowering arm 51 for raising/lowering the raising/lowering arm 51 in a longitudinal direction includes the drive motor and a pinion 68 to which the rotary driving force of the drive motor is transmitted in a decelerated state and engaging with the rack teeth 56 of the raising/lowering arm 51, and the driving force transmitting means 52 and the raising/lowering arm 51 structure a rack and pinion mechanism.

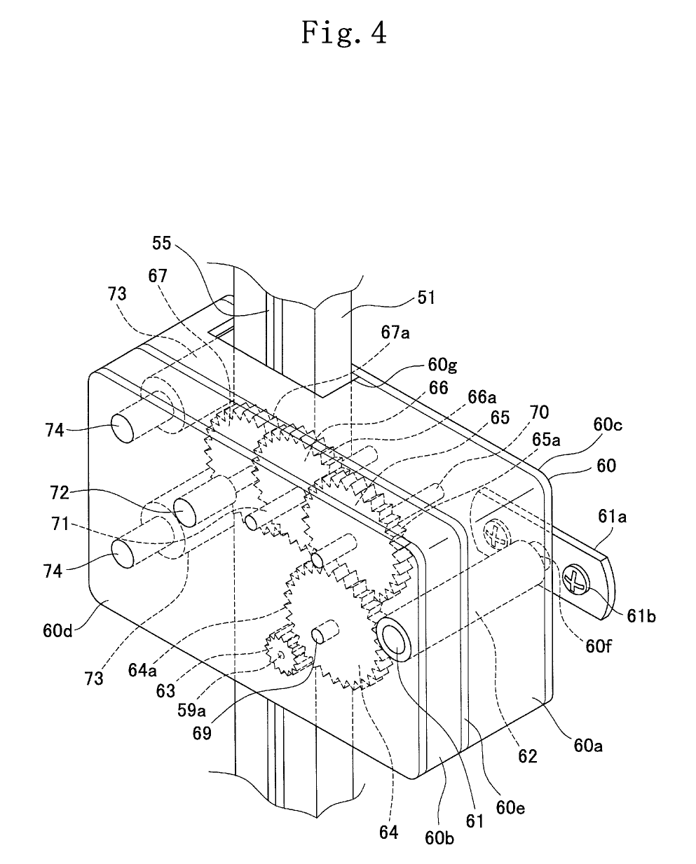

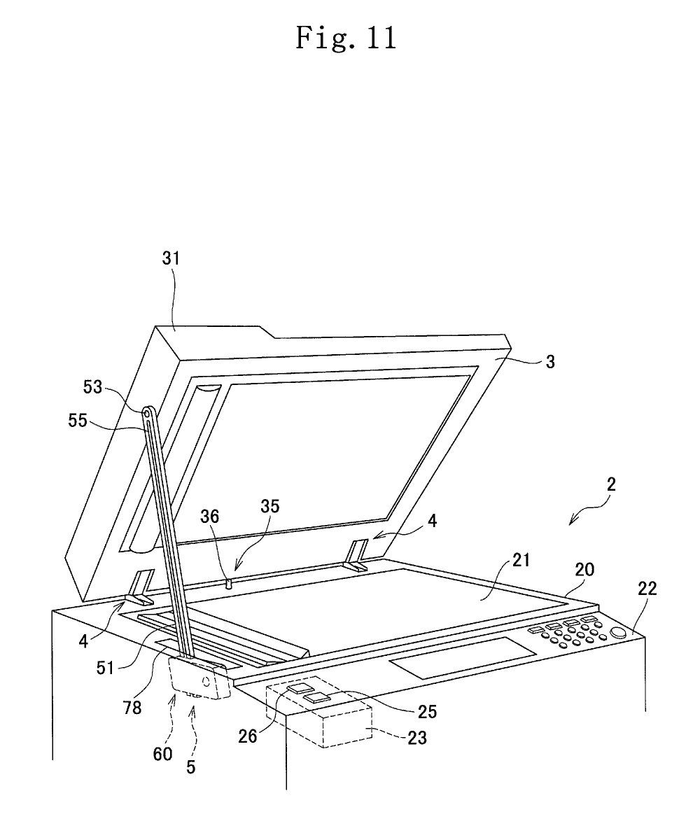

The drive motor is, for instance, a pulse motor 59 or the like. The pulse motor 59 is attached in a drive case 60. The drive case 60 is formed of two frame members 60a, 60b, both wall portions 60c, 60d, and an intermediate wall portion 60e. The drive case 60 is rotatably attached to the side surface of the main body 20. A rotary support shaft 61 is attached in a protruding manner to a portion in the lower part of a portion to which the raising/lowering arm 51 on the side surface of the original cover 3 is rotatably attached and in the upper part of the side surface of the main body 20. The rotary support shaft 61 protrudes, for instance, to a mounting piece 61a having a substantially rectangular flat plate shape, and the mounting piece 61a is attached to the side surface of the main body 20 using, for instance, a machine screw 61b or the like (refer to FIG. 4), to thereby attach the rotary support shaft 61 to the main body 20 in a protruding manner. On a substantially central portion in a height direction in the vicinity of one side surface (side surface on a front surface side of the main body) of the drive case 60, a through hole 60f is provided, and when the rotary support shaft 61 is inserted into the through hole 60f via a guide member 62, the drive case 60 is attached to the side surface of the main body 20 in a rotatable manner, namely, in a swingable manner in a raising/lowering direction. Note that the drive case 60 of the driving force transmitting means 52 may also be placed inside the main body 20, as shown in FIG. 11, and in this case, the main body 20 is provided with a guide groove 78 from which the raising/lowering arm 51 protrudes above the main body 20 and performs raising/lowering operation. As above, by housing the drive case 60 and a part of the raising/lowering arm 51 in the main body 20, it is possible to improve an appearance.

As shown in FIG. 4 to FIG. 7, a rotary gear 63 is attached to a rotary shaft 59a of the pulse motor 59. The rotary gear 63 is engaged with a gear wheel 64a of a first gear 64. The first gear 64 is rotatably attached to the drive case 60 via a support shaft 69, and includes the gear wheel 64a whose diameter is larger than that of the rotary gear 63, and a pinion 64b whose diameter is smaller than that of the gear wheel 64a. The pinion 64b is engaged with a gear wheel 65a of a second gear 65. The second gear 65 is rotatably attached to the drive case 60 via a support shaft 70, and includes a pinion 65b whose diameter is smaller than that of the gear wheel 65a. The pinion 65b is engaged with a gear wheel 66a of a third gear 66. The third gear 66 is rotatably attached to the drive case 60 via a support shaft 71, and includes a pinion 66b whose diameter is smaller than that of the gear wheel 66a. The pinion 66b is engaged with a gear wheel 67a of a pinion portion 67. The pinion portion 67 is rotatably attached to the drive case 60 via a support shaft 72, and includes a pinion 68 provided via the gear wheel 67a and a small-diameter portion 72a. The small-diameter portion 72a is formed having a diameter smaller than the width of the opening portion of the recessed portion 55 of the raising/lowering arm 51. Further, the pinion 68 is formed having a diameter larger than the width of the opening portion of the recessed portion 55 of the raising/lowering arm 51 and at which it engages with the rack teeth 56.

Accordingly, the rotary driving force of the pulse motor 59 is transmitted in a decelerated state to the pinion 68 via the first to third gears 64, 65 and 66, and the pinion portion 67. Further, insertion holes 60g are provided on top and bottom surfaces of the drive case 60 in the direction of another side surface, into which the raising/lowering arm 51 is inserted in a state of passing through in a longitudinal direction between the wall portion 60c and the intermediate wall portion 60e of the drive case 60 on the main body 20 side. Further, in the drive case 60, guide rollers 73 being guide members for guiding the raising/lowering arm 51 passing through the drive case 60 via the insertion holes 60g are provided. The guide roller 73 is rotatably provided on an outer periphery of a shaft 74 provided in the drive case 60 between the wall portion 60c and the intermediate wall portion 60e. Two guide rollers 73, namely, a pair of guide rollers 73 are provided in the drive case 60 in the height direction thereof. It is structured such that the pinion 68 is positioned in the recessed portion 55 of the raising/lowering arm 51 inserted in the drive case 60, and when the pinion 68 and the rack teeth 56 are engaged with each other, the raising/lowering arm 51 is guided by the pinion 68 and the pair of guide rollers 73 so that the movement thereof in the left and right directions is controlled, and is raised/lowered by the rotation of the pinion 68, which realizes an automatic opening/closing of the original cover 3.

Further, it is preferable that an angle detection sensor (not shown) that detects an angle of the original cover 3 with respect to the main body 20 is connected to the rotary shaft 46. The angle detection sensor is not limited in particular, and, for instance, an encoder or the like is used. Further, a disposition spot of the angle detection sensor is not limited in particular as long as the angle of the original cover 3 with respect to the main body 20 can be detected at that spot.

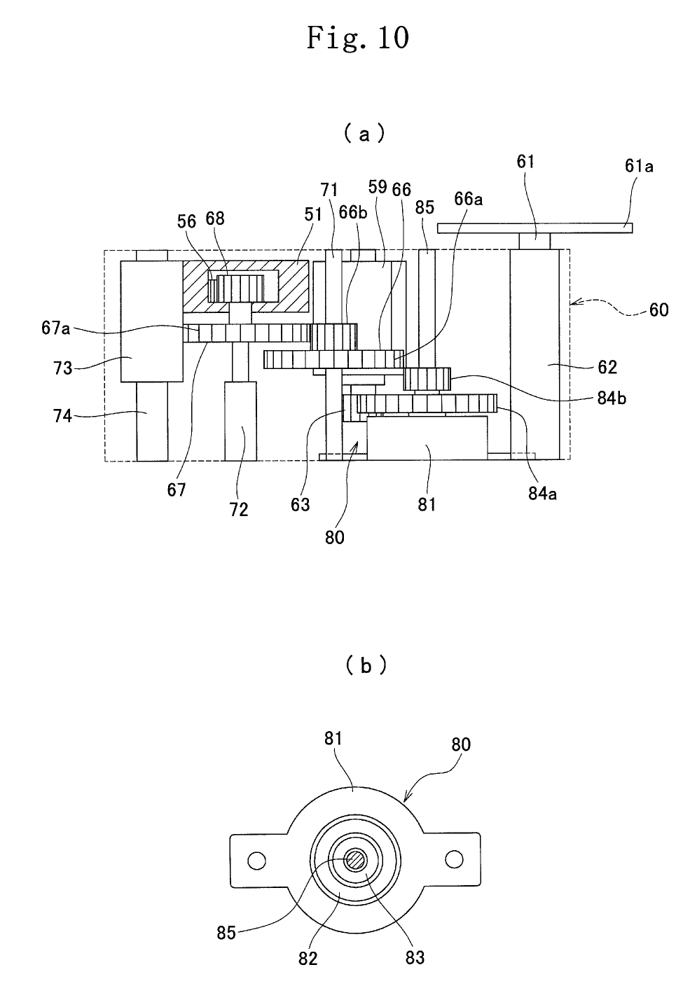

Besides, the driving part 5 is preferably provided with a clutch means so that the original cover 3 can be opened/closed with a small amount of force when it is opened manually. The clutch means is not limited in particular, and it can be a mechanical or electrical one as long as it can cut a rotation torque transmitted to the pulse motor 59 when the original cover 3 is opened/closed manually. FIG. 10A and FIG. 10B show an example in which an electromagnetic clutch is used, in which the electromagnetic clutch 80 is turned to an ON state when the pulse motor 59 operates. For easier understanding, the support shaft 70 and the gear wheel 65a and the pinion 65b attached to the support shaft 70 are omitted in FIG. 10A. FIG. 10B illustrates only a part of the electromagnetic clutch 80. The electromagnetic clutch 80 is formed of an outer rotary body 82 and an inner rotary body 83 provided in a clutch case 81 attached in the drive case 60, and connects or disconnects the outer rotary body 82 and the inner rotary body 83 using an electromagnet, in which as an operation means using the electromagnet, a solenoid method, a method in which magnetic iron powder (powder) disposed between the outer rotary body 82 and the inner rotary body 83 is magnetized, or the like can be conceivable. As above, when the gear wheel 84a engaging with the rotary gear 63 attached to the rotary shaft of the pulse motor 59 is fixed to the outer rotary body 82, and the pinion 84b attached to a support shaft 85 in which an axial center is common with the gear wheel 84a is fixed to the inner rotary body 83, since the connection between the outer rotary body 82 and the inner rotary body 83 is cut when the original cover 3 is operated manually, the rotation torque in accordance with the manual operation is not transmitted to the pulse motor 59, resulting that the opening/closing operation can be realized with a small amount of force with no electric brake applied thereto. On the other hand, when the pulse motor 59 is turned to an ON state at the time of automatically opening/closing the original cover 3, the outer rotary body 82 and the inner rotary body 83 are in a connected state with the use of the electromagnetic force, so that the gear wheel 84a and the pinion 84b rotate together and the rotary driving force of the pulse motor 59 is transmitted to the original cover 3, resulting that the original cover 3 can be opened/closed automatically. The above is explained regarding a case in which the electromagnetic clutch 80 is fixed to the drive case 60, but, it is also possible to structure such that the electromagnetic clutch 80 rotates together with the gear wheel 84a or the pinion 84b. In addition, the electromagnetic clutch can also be provided in another gear.

A controller 23 controls the pulse motor 59 and the like when the original cover 3 is rotated in the opening direction or in the closing direction. Note that the controller 23 is provided in the main body 20 in an example shown in FIG. 1, but, it is not limited to this. The controller 23 is provided with an automatic rotary opening function to automatically rotate the original cover 3 in the opening direction by, for instance, performing pushing operation of an automatic open switch 25 for the original cover provided on an operation panel 22 of the main body 20 to drive the pulse motor 59, and an automatic rotary closing function to automatically rotate the original cover 3 at an opening position in the closing direction by, for instance, performing pushing operation of an automatic close switch 26 for the original cover provided on the operation panel 22 of the main body 20 to drive the pulse motor 59. Note that the opening position in the present invention indicates that the original cover 3 is located at a position at which an original is mountable on the contact glass 21, and indicates a case of positioning the original cover 3 at the maximum usable opening angle (including substantially maximum usable opening angle), and so on.

The automatic rotary opening function is for automatically rotating the original cover 3 at a closing position in the opening direction by, for instance, performing the pushing operation of the automatic open switch 25 for the original cover to drive the pulse motor 59. Note that it is also possible that in the automatic rotary opening function, the original cover 3 is not rotated automatically in the opening direction immediately after performing, for instance, the pushing operation of the automatic open switch 25 for the original cover, but after the original cover 3 is rotated manually in the opening direction to the predetermined opening angle, the pulse motor 59 is driven to automatically rotate the original cover 3 in the opening direction so that the original cover 3 is positioned at the maximum usable opening angle (including substantially maximum usable opening angle). Specifically, it is possible that when the original cover 3 reaches the predetermined opening angle from its closed state, the pulse motor 59 is turned on so that the original cover 3 automatically rotates at the maximum usable opening angle (including substantially maximum usable opening angle).

The automatic rotary closing function is not limited in particular as long as it can automatically rotate the original cover 3 at the opening position in the closing direction, and it may include a low-speed function in which the rotating speed of the original cover 3 in the closing direction is adjusted to a lower speed to suppress an impact of the original cover 3 on the main body 20, and to make the original cover 3 appress against the main body 20 without being in a floating state. The low-speed function of the automatic rotary closing function preferably controls, based on signals from an open/close sensor, the angle detection sensor or the like, the pulse motor 59 so as to suspend the rotation of the original cover 3 in the closing direction when the original cover 3 is appressed against the main body 20. Note that it is also possible that in the automatic rotary closing function, the rotation of the original cover 3 in the closing direction is performed manually or by its own weight by suspending the driving of the pulse motor 59 or by stopping the transmission of the rotary driving force of the pulse motor 59 to the rotary shaft 46 by activating the electromagnetic clutch 80, when the original cover 3 is positioned at an angle equal to or less than the predetermined closing angle at the time of automatically rotating the original cover 3 in the closing direction.

Note that the closing angle in the present invention is an angle of the original cover 3 with respect to the surface of the contact glass 21 being the upper surface of the main body 20, which is the same as the opening angle. However, when the original cover 3 is rotated in the closing direction, an angle of the original cover 3 with respect to the surface of the contact glass 21 is sometimes referred to as the closing angle, for convenience sake. The predetermined closing angle in the present invention is not limited in particular as long as it is an angle equal to or less than the aforementioned predetermined opening angle, and it is, for instance, 15° (including around 15°).

Further, it is also possible that the automatic rotary opening function and the automatic rotary closing function are provided with a suspension function to suspend the driving of the pulse motor 59 when a large torque which is different from a torque to rotate the original cover 3 is generated at the time of automatically rotating the original cover 3 in the opening direction or in the closing direction. As a means to detect a torque, a torque detection sensor may be provided in the rotary shaft 46 or the like, or the suspension function may be structured so as to suspend the driving of the pulse motor 59 by assuming that a large torque is generated when the pulse of the pulse motor 59 and the angle of the rotary shaft 46 obtained from the angle detection sensor are compared and it is found that the angle of the rotary shaft 46 is deviated from the supposed angle of the rotary shaft 46 obtained from the pulse of the pulse motor 59.

Further, the controller 23 may also be provided with a function to ensure closure. The function to ensure closure is, for instance, to automatically rotate, when the original cover 3 is recognized to be still in an opening position even after a predetermined period of time elapses based on a signal from an open/close sensor 35, the angle detection sensor (encoder) or the like, the original cover 3 in the closing direction by assuming that the original cover 3 is forgotten to be closed. Thus, by providing the function to ensure closure, it is possible to prevent the original cover 3 from being forgotten to be closed.

The open/close sensor 35 is disposed, for instance, in the vicinity of the hinge part 4 of the main body 20 to detect whether the original cover 3 is in the opening position or in the closing position. As the open/close sensor 35, either a non-contact type sensor or a contact type sensor is usable, and in the illustrated example, it is a contact-type sensor. The contact-type open/close sensor 35 sends an electric signal indicating that the original cover 3 is in the opening position when a contact 36 urged in the protruding direction protrudes from the main body 20, and sends an electric signal indicating that the original cover 3 is in the closing position in which the contact 36 is installed in the main body 20 against the urging force from the main body 20, when the original cover 3 is appressed against the main body 20. Note that it is also possible to detect the opening/closing of the original cover 3 by sending the signal when the contact 36 is in either state of being protruded from the main body 20 or state of being installed in the main body 20.

Further, the controller 23 may also be provided with an auxiliary function to generate an auxiliary force when the original cover 3 is rotated in the opening direction or in the closing direction at the time of manually performing the opening/closing operation of the original cover 3. The auxiliary function serves, for instance, to assist the rotation of the original cover 3 when the original cover 3 makes a predetermined angle based on a signal from the encoder at the time of rotating the original cover 3 in a state in which the automatic open switch 25 for the original cover or the automatic close switch 26 for the original cover is not operated. The auxiliary function especially at the time of rotating in the closing direction preferably possesses a function to drive, when the original cover 3 is rotated in the closing direction, the pulse motor 59 to rotate the original cover 3 at a low speed at an angle equal to or less than the predetermined opening angle (for instance, around 10° or less) of the original cover 3. Thus, by providing the auxiliary function, the manual rotation of the original cover 3 can be easily performed.

Further, the auxiliary function may also serve to detect the rotation of the original cover 3 based on the signal from the encoder when the original cover 3 is manually rotated in the opening direction or in the closing direction from a state in which the automatic open switch 25 for the original cover or the automatic close switch 26 for the original cover is not operated and the original cover 3 is suspended, and to drive the pulse motor 59 so as to assist the rotation of the original cover 3. Specifically, it is also possible to structure the auxiliary function so that the opening/closing of the original cover 3 can be performed with a small amount of force by adding the auxiliary force in accordance with the movement of the original cover 3. Accordingly, it becomes possible to easily open/close the original cover 3 manually.

Further, the controller 23 may also be provided with an automatic opening/closing function. For example, the automatic opening/closing function may serve to drive, when the original cover 3 is manually rotated in the opening direction or in the closing direction from a state in which the automatic open switch 25 for the original cover or the automatic close switch 26 for the original cover is not operated and the original cover 3 is suspended, the pulse motor 59 based on the signal from the encoder so that the opening/closing of the original cover 3 is automatically performed. Specifically, the automatic opening/closing function may be structured such that when the original cover 3 is manually opened/closed, the original cover 3 starts to be opened/closed automatically in its operational direction. Accordingly, it becomes possible to easily open/close the original cover 3.

Further, the controller 23 is preferably provided with a clutch function to operate the electromagnetic clutch 80 to stop the transmission of the rotary driving force of the pinion 68 to the pulse motor 59 side when the original cover 3 is opened/closed manually. The clutch function is, for instance, to stop the transmission of the rotary driving force of the pinion 68 to the pulse motor 59 side until the original cover 3 reaches the predetermined opening position when it is opened/closed manually.

Next, an operation of a first original cover closer 1 according to the present invention will be described.

Normally, a state in which the office equipment 2 is not used corresponds to the close state (refer to FIG. 8) in which the original cover 3 is appressed against the contact glass 21 of the main body 20. In order to manually rotate the original cover 3 for placing an original on the surface of the contact glass 21, the original cover 3 is first lifted upward by holding a front part of the original cover 3 (an end portion at an opposite side of a portion where the hinge part 4 is attached or in the vicinity thereof). Specifically, the original cover 3 is rotated around the rotary shaft 46 to expose the surface of the contact glass to the outside and is located at, for example, the opening position (opening angle is substantially 70°), as shown in FIG. 1 and FIG. 9. At this time, by stopping the transmission of power between the pinion 68 and the pulse motor 59 using the electromagnetic clutch 80, a detent torque or the like of the pulse motor 59 is not acted as a friction load when the original cover 3 is opened, so that the original cover 3 can be opened with no friction load applied thereto.

Further, to automatically open the original cover 3, the pushing operation of the automatic open switch 25 for the original cover is performed, for instance. When the automatic open switch 25 for the original cover is operated, the pulse motor 59 is driven. When the pulse motor 59 is driven, the rotary driving force of the pulse motor 59 is transmitted to the pinion 68 via the first to third gears 64, 65 and 66 to rotate the pinion 68, the raising/lowering arm 51 moves in the upward direction via the rack teeth 56 engaging with the pinion 68, the original cover 3 is automatically opened by the force of the raising/lowering arm 51 in the upward direction, the surface of the contact glass is exposed to the outside, and the original cover 3 reaches the opening position. Accordingly, it is possible to place the original on the exposed surface of the contact glass 21.

When the lifted original cover 3 is manually pulled down (closed) after the original is placed on the surface of the contact glass 21, the original cover 3 is rotated in the closing direction, resulting that the original cover 3 rotates around the rotary shaft 46 in the direction in which it is in contact with the contact glass 21 (moves downward). When the original cover 3 is rotated in the closing direction as described above, at first, some force is required to resist the urging force of the compression spring 44a. However, for example, when the opening angle of the original cover 3 reaches 20° (including around 20°) or less, the moment of the original cover 3 becomes larger than the urging force that urges the original cover 3 using the compression spring 44a, so that it is possible to easily rotate the original cover 3. At this time, since the fluid damper device 144 is provided, when the opening angle of the original cover 3 reaches, for instance, 10° (including around 10°), the rotating speed of the original cover 3 is reduced by the fluid damper device 144, so that the original cover 3 does not collide with the contact glass 21 vigorously. Further, if the electromagnetic clutch 80 is driven when the rotating speed of the original cover 3 in the closing direction becomes fast, a rotation force of the pinion 68 is transmitted to the pulse motor 59, and the detent torque or the like of the pulse motor 59 is applied as the friction load, resulting that the rotating speed of the original cover 3 is reduced. As a result, a chance in which the original cover 3 vigorously collides with the contact glass 21 is further reduced.

Besides, if an original 15 is thick such as a thick book, when the original cover 3 is rotated in the closing direction (moved downward), a part in the vicinity of the supporting member 42 of the original cover 3 is in contact with the end portion of the original on the supporting member 42 side or in the vicinity thereof, and a space is formed between the end portion at the opposite side from the end portion of the original on the supporting member 42 side and the original cover 3. Namely, the original cover 3 becomes in a floating state. When the floating original cover 3 is pressed toward the contact glass 21 side, the operation pin 49 presses the first slider 141 toward the second slider 142 side, the first slider 141 moves toward the second slider 142 side against the urging force of the compression spring 44a, and the original cover 3 rotates around the hinge pin 47. Specifically, the original cover 3 moves so as to cover the upper portion of the original (refer to FIG. 2B). For example, when the upper portion of the original is a flat surface, the original cover 3 is in surface contact with the upper portion. Accordingly, the original having a large thickness is stably appressed against on the surface of the contact glass 21. The closing operation can be conducted automatically, which is one of the characteristics of the present invention. Namely, when the pushing operation of the automatic close switch 26 for the original cover is performed after the original having a large thickness is placed on the contact glass, the pulse motor 59 rotates in the opposite direction to the opening direction of the original cover 3, and the raising/lowering arm 51 moves downward, resulting that the original cover 3 can be closed. This characteristic is realized by the fact that the raising/lowering arm 51 supports the side portion of the original cover 3 at the forward side of the hinge part 4.

Further, to automatically close the original cover 3 at a normal time, the pushing operation of the automatic close switch 26 for the original cover is performed, for instance. When the automatic close switch 26 for the original cover is operated, the pulse motor 59 is rotary driven in the opposite direction to the opening direction. When the pulse motor 59 is driven, the rotary driving force of the pulse motor 59 is transmitted to the pinion 68 via the first to third gears 64, 65 and 66 to rotate the pinion 68, the raising/lowering arm 51 moves in the downward direction via the rack teeth 56 engaging with the pinion 68, the original cover 3 is automatically closed by the force of the raising/lowering arm 51 in the downward direction, and the original cover 3 is appressed against the surface of the contact glass. At this time, if the automatic rotary closing function possesses the low-speed function, the pulse motor 59 is controlled when the original cover 3 is positioned at an angle equal to or less than the predetermined opening angle and the rotating speed in the direction in which the original cover 3 is closed is reduced according thereto, resulting that the original cover 3 does not collide with the contact glass 21 vigorously.

As above, the original cover 3 is automatically opened/closed by the raising/lowering operation of the raising/lowering arm 51 attached at the forward side of the hinge part 4 of the original cover 3, in which a portion at which the force is acted on the original cover 3 when opening/closing the original cover 3 is distant from the hinge part 4, so that it is possible to open/close the original cover 3 with a small amount of force compared to a case in which the force is acted on the hinge part 4, for instance, the rotary shaft 46 to operate the original cover 3, and thus there is no need to use a high-power motor as a drive motor. As a result, it becomes possible to realize not only the miniaturization of the driving part 5 but also the reduction in cost. Accordingly, it becomes possible to realize the miniaturization of the first original cover closer 1 according to the present invention and the low cost.

Further, since the horizontal position control means 45 is provided on the lifting member 43, it becomes possible to adjust the position of the original cover 3 with respect to the contact glass 21, which makes it possible to appress the original against the contact glass 21 more stably.

Further, if a drive motor is the pulse motor 59, when a large torque different from a torque to rotate the original cover 3 is generated at the time of automatically rotating the original cover 3 in the opening direction or in the closing direction, the pulse motor 59 is stepped out, so that it is possible to prevent a damage of motors and the other parts such as the driving part 5.

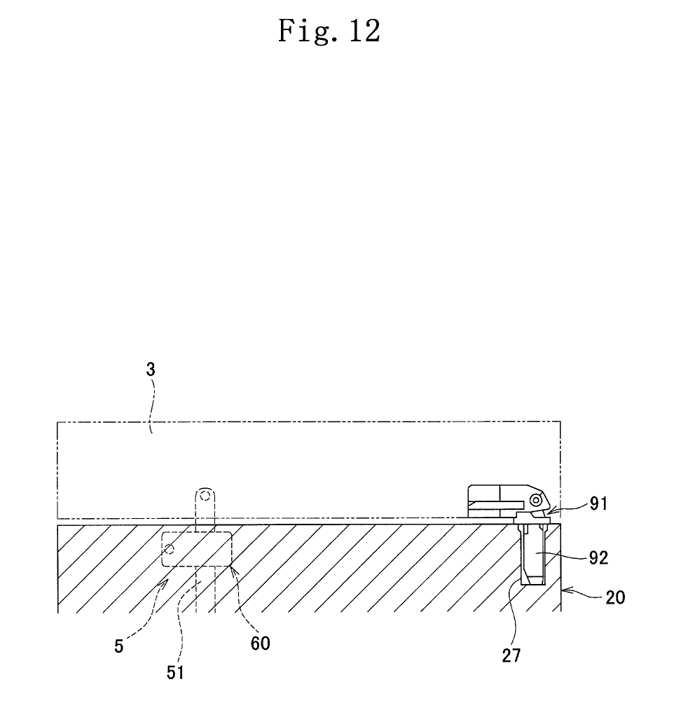

Note that a case in which the lifting member 43 rotatably attached to the supporting member 42 is used as the lift mechanism was described, but, it is not limited to this. For example, as shown in FIG. 12, the lift mechanism can also be structured by inserting a leg portion 92 provided to a mounting member 91 into a mounting hole 27 provided in the vicinity of the rear end portion of the upper surface of the main body 20 and extending in the height direction. Further, it is also possible that the leg portion 92 is formed in a cylindrical shape, and a slider is accommodated in this leg portion 92.

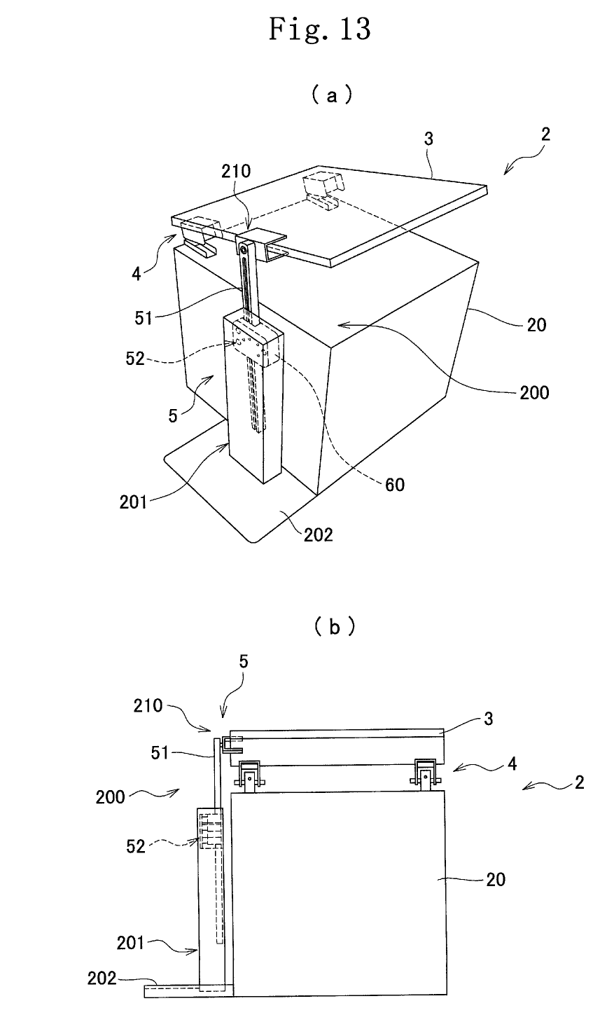

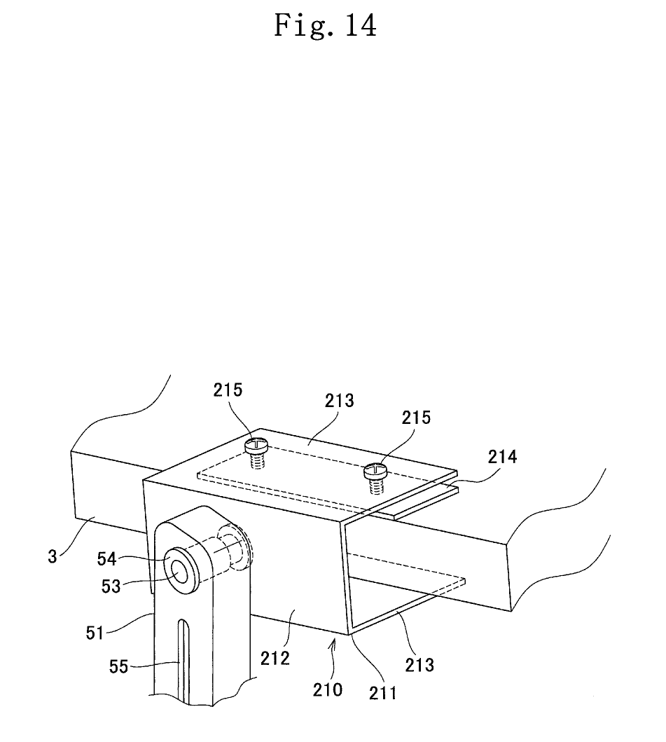

FIGS. 13A and 13B are views showing an example of an office equipment provided with a second original cover closer according to the present invention. In these views, the main body and the original cover are illustrated in simplified form for easier understanding of a structure of the second original cover closer. FIG. 14 is a view showing another example of the tip portion of the raising/lowering arm according to the present invention. As shown in FIGS. 13A and 13B, a second original cover closer 200 attaches the driving part 5 to a stand 201 provided in the vicinity of the side surface of the main body 20, and attaches the tip portion of the raising/lowering arm 51 to the original cover 3 using a holding means 210, and the other structure thereof is the same as the structure of the first original cover closer 1, so that an explanation thereof will be omitted.

The stand 201 is disposed on a floor or the like in the vicinity of the side surface of the main body 20. The stand 201 is formed in, for example, a rectangular cylindrical shape extending in the upward direction until it reaches the vicinity of the upper portion of the main body and a part of an upper portion thereof (a portion from which the raising/lowering arm 51 protrudes and performs raising/lowering operation) is opened. On an upper part in the stand 201, the drive case 60 of the driving part 5 is rotatably (swingably in the raising/lowering direction) attached, and a part of the raising/lowering arm 51 is installed in the stand 201. At a lower part of the stand 201, a mounting plate 202 mounted on a floor or the like is provided for stably setting up the stand 201. The mounting plate 202 is fixed by mounting a part of the main body 20 on a part thereof, and the stand 201 can be set up on the fixed mounting plate 202. Further, by providing the drive case 60 of the driving part 5 on the upper part in the stand 201, no holes or the like for attaching the driving part 5 to the side surface of the main body 20 are opened. Further, by housing the drive case 60 and a part of the raising/lowering arm 51 in the stand 201, it is possible to improve an appearance.

The holding means 210 attaches the tip portion of the raising/lowering arm 51 to the original cover 3 using two holding pieces. The holding means 210 is not limited in particular, and it can be structured by a U-shaped holding body 211 having two holding parts 213, and a holding piece 214 movably attached to one holding part 213 in a state of opposing the other holding part 213, as shown in FIG. 14. Note that as the holding means 210, one in which two holding pieces are formed in a movable manner and these two holding pieces are urged by a resilient member so that a space between the holding pieces becomes narrow, can also be applied. To an outer surface of a base part 212 of the holding body 211, the tip portion of the raising/lowering arm 51 is rotatably attached. The holding piece 214 is formed, for instance, in a rectangular flat plate shape, and is structured such that a space between the one holding part 213 and the other holding part 213 can be adjusted by a machine screw 215 or the like screwed to the one holding part 213. By attaching the tip portion of the raising/lowering arm 51 to the original cover 3 using the holding means 210 as described above, it is possible to easily adjust the mounting position of the raising/lowering arm 51 with respect to the original cover 3, and no holes or the like for attaching the raising/lowering arm 51 to the original cover 3 are opened. Note that it is also possible that the raising/lowering arm 51 is attached to the original cover 3 using the holding means 210 in the first original cover closer 1.

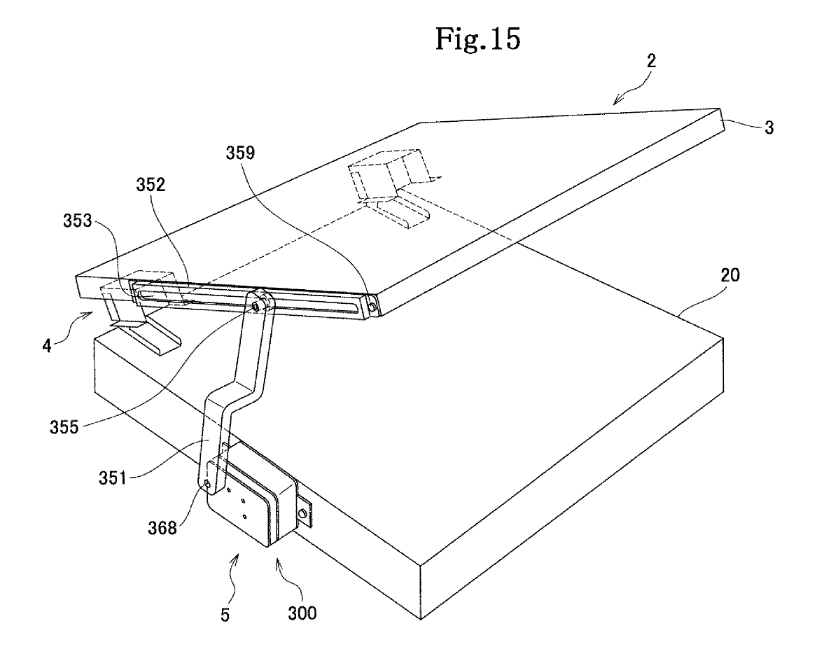

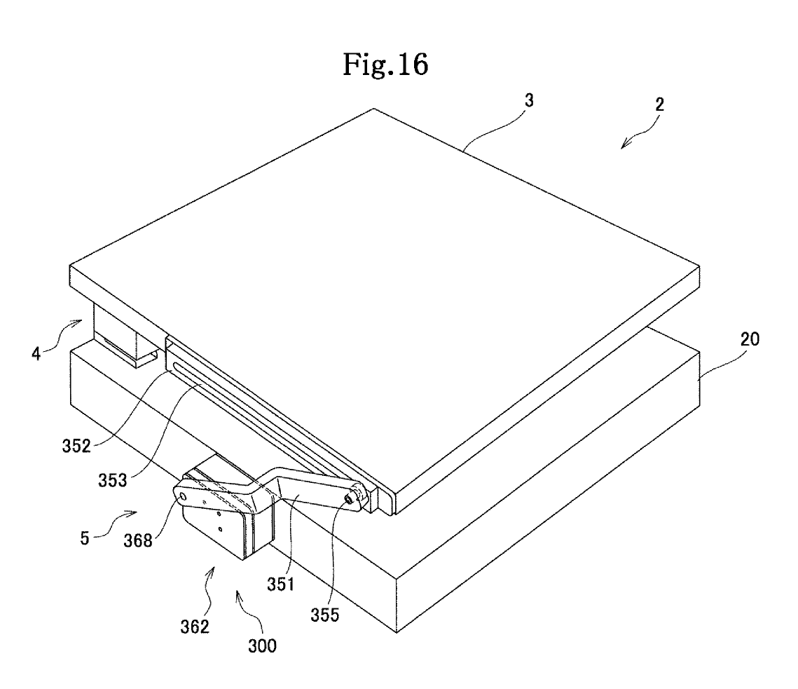

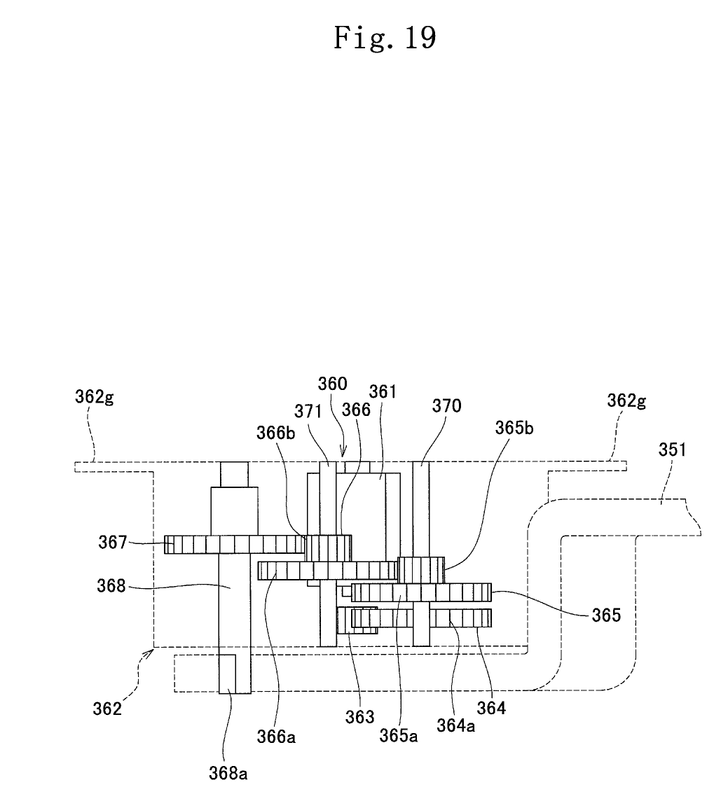

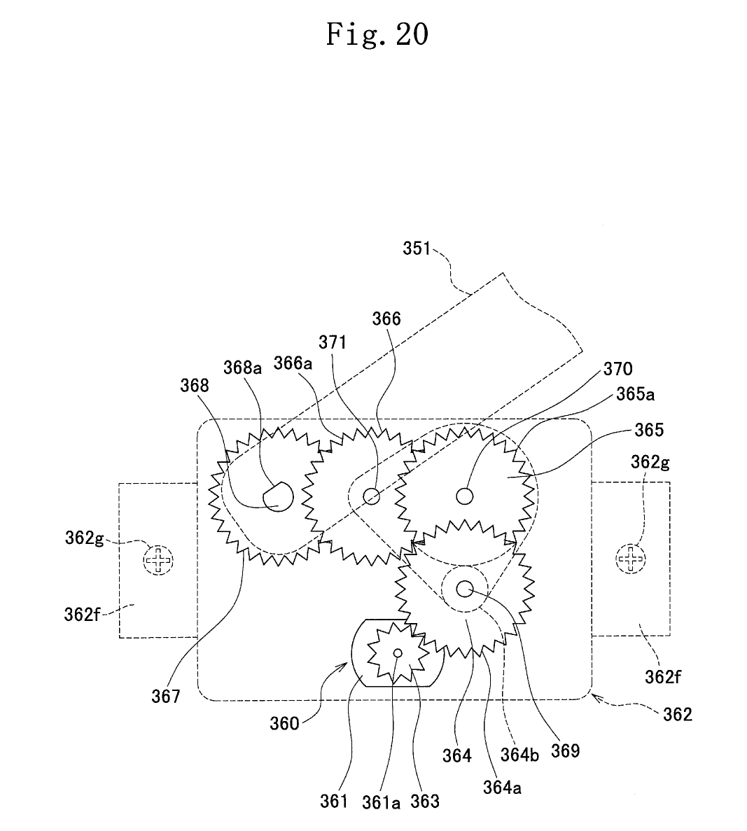

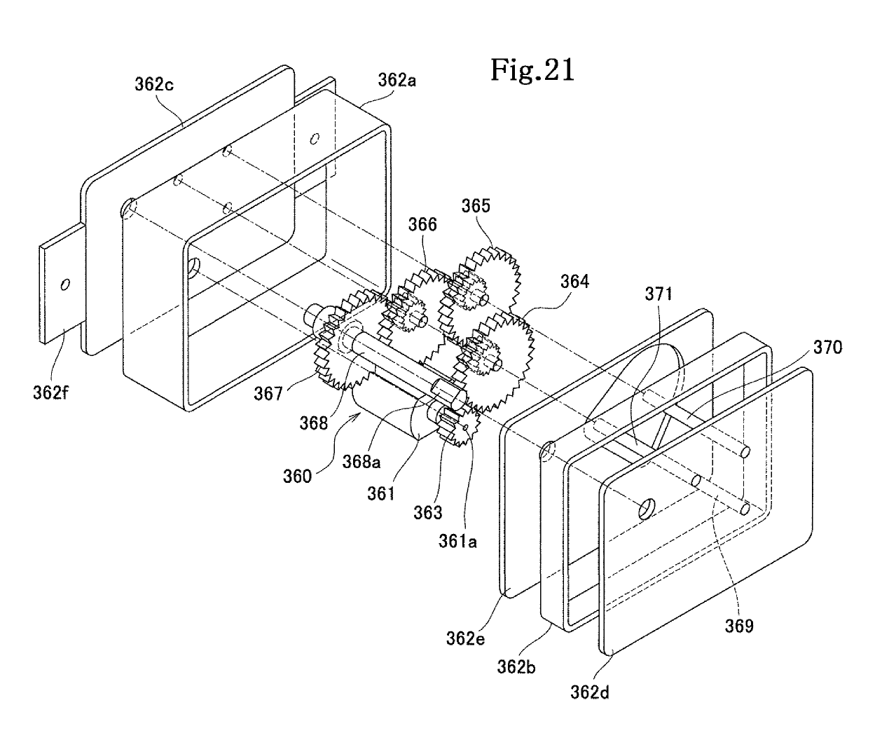

FIG. 15 and FIG. 16 are views showing an example of an office equipment provided with a third original cover closer according to the present invention. In these views, the main body and the original cover are illustrated in simplified form for easier understanding of a structure of the third original cover closer. The third original cover closer is characterized in that the driving part 5 is formed of a rotary arm 351 being a drive arm rotatably attached to the original cover 3 in a slidable manner in the forward and backward directions thereof, and a rotation driving means 360 shown in FIG. 19 to FIG. 21 being a driving force transmitting means that rotates the rotary arm 351. Note that the same members as those of the first original cover closer 1 are denoted by the same reference numerals and an explanation thereof may be omitted.

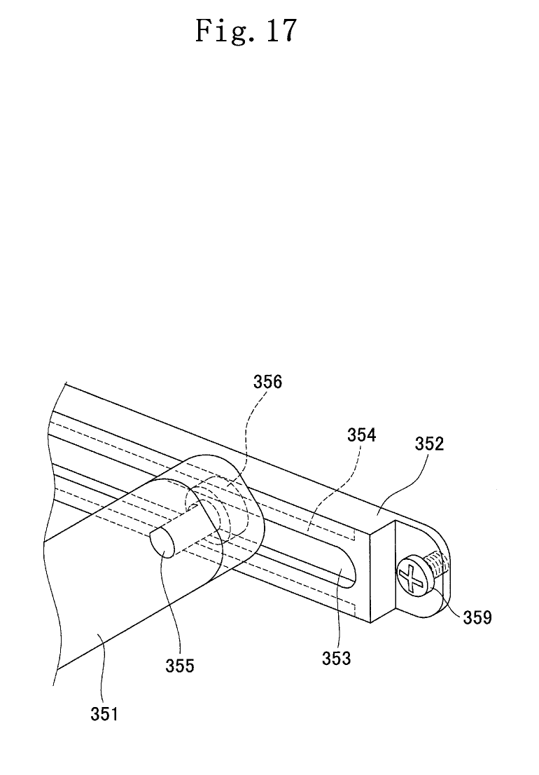

As shown in FIG. 15 to FIG. 20, the rotary arm 351 is formed in a long bar shape having a rectangular cross section, and an upper part thereof is bent in a crank shape so that it comes close to the original cover 3. One end portion to be an upper end portion of the rotary arm 351 is rotatably, namely, swingably attached to one side surface of the original cover 3 in a slidable manner in the forward and backward directions of the original cover 3. A guide member 352 is attached to the one side surface of the original cover 3 with a machine screw 359 or the like. On a surface of the guide member 352, an engaging recessed portion 353 being a guide groove extending in the longitudinal direction is provided. An inside of the engaging recessed portion 353 is formed as an engaging portion 354 whose width is larger than a width of an opening portion. To one end portion of the rotary arm 351, an engaging shaft 355 to be inserted into the engaging recessed portion 353 is fixed. A roller member 356 having a diameter of, for instance, substantially the same or slightly smaller than the width of the engaging portion 354 is rotatably attached to an outer periphery of the engaging shaft 355 inside the engaging recessed portion 353. Accordingly, the one end portion of the rotary arm 351 is rotatably attached to the one side surface of the original cover 3 in a slidable manner in the forward and backward directions of the original cover 3 via the guide member 352.

The rotation driving means 360 that rotates the rotary arm 351 is not limited in particular as long as it can rotate the rotary arm 351, and includes, for instance, a reversibly rotatable drive motor. The drive motor is, for example, a pulse motor 361 or the like. The pulse motor 361 is attached in a drive case 362. The drive case 362 is formed of two frame members 362a, 362b, both side walls 362c, 362d, and an intermediate wall 362e. The drive case 362 is attached to the side surface of the main body 20 via a mounting piece 362f using a machine screw 362g.

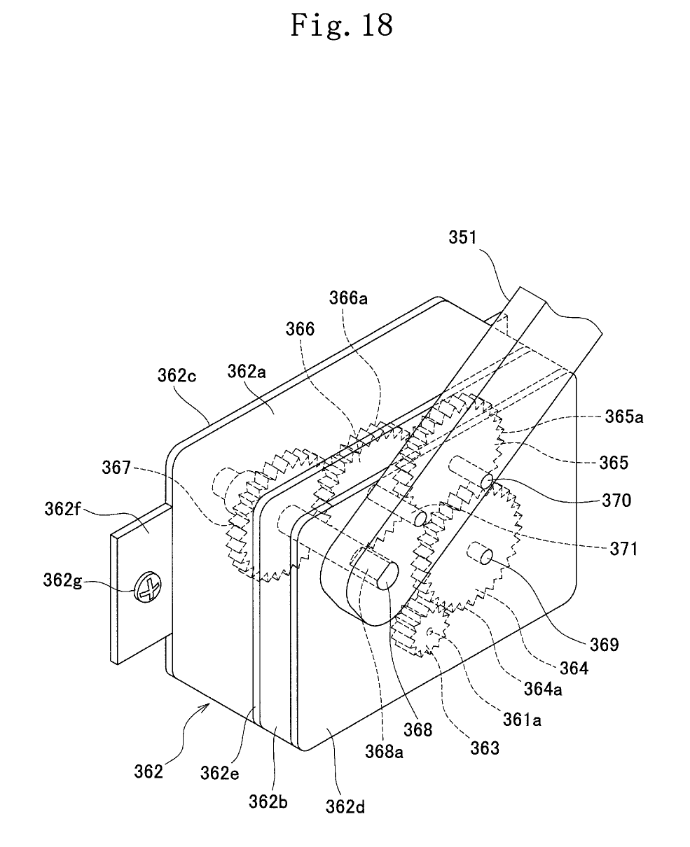

As shown in FIG. 18 to FIG. 21, a rotary gear 363 is attached to a rotary shaft 361a of the pulse motor 361. The rotary gear 363 is engaged with a gear wheel 364a of a first gear 364. The first gear 364 is rotatably attached to the drive case 362 via a support shaft 369, and includes the gear wheel 364a whose diameter is larger than that of the rotary gear 363, and a pinion 364b whose diameter is smaller than that of the gear wheel 364a. The pinion 364b is engaged with a gear wheel 365a of a second gear 365. The second gear 365 is rotatably attached to the drive case 362 via a support shaft 370, and includes a pinion 365b whose diameter is smaller than that of the gear wheel 365a. The pinion 365b is engaged with a gear wheel 366a of a third gear 366. The third gear 366 is rotatably attached to the drive case 362 via a support shaft 371, and includes a pinion 366b whose diameter is smaller than that of the gear wheel 366a. The pinion 366b is engaged with a fourth gear 367. The fourth gear 367 is attached to a rotary shaft 368 rotatably attached to the drive case 362. An end portion of the rotary shaft 368 on a surface side thereof (opposite side of the main body) protrudes from the surface and formed as an engaging portion 368a. The engaging portion 368a is formed in a non-circular shape, for instance, a shape made by cutting out a part of a circular shape. The engaging portion 368a is attached to the end portion of the rotary arm 351 in a state of being fitted therein. Accordingly, it is structured such that a rotary driving force of the pulse motor 361 is transmitted in a decelerated state to the fourth gear 367 via the first to third gears 364, 365 and 366, and the rotary arm 351 is rotated via the rotary shaft 368, resulting that the original cover 3 is opened/closed automatically.

If the third original cover closer 300 is structured as above, it can achieve the same operation and effect as those of the aforementioned first original cover closer 1. Specifically, a state in which the office equipment 2 is not used normally corresponds to the close state (refer to FIG. 16) in which the original cover 3 is appressed against the contact glass 21 of the main body 20. In order to manually rotate the original cover 3 for placing the original on the surface of the contact glass 21, the original cover 3 is first lifted upward by holding a front part of the original cover 3 (an end portion at an opposite side of a portion where the hinge part 4 is attached or in the vicinity thereof). Specifically, the original cover 3 is rotated around the rotary shaft 46 to expose the surface of the contact glass to the outside and is located at, for example, the opening position (opening angle is substantially 70°). At this time, by stopping the transmission of power between the pinion 68 and the pulse motor 361 using the electromagnetic clutch 80, a detent torque or the like of the pulse motor 361 is not acted as a friction load when the original cover 3 is opened, so that the original cover 3 can be opened with no friction load applied thereto.

Further, to automatically open the original cover 3, the pushing operation of the automatic open switch 25 for the original cover is performed, for instance. When the automatic open switch 25 for the original cover is operated, the pulse motor 361 is driven. When the pulse motor 361 is driven, the rotary driving force of the pulse motor 361 is transmitted to the fourth gear 367 via the first to third gears 364, 365 and 366 to rotate the rotary arm 351 via the rotary shaft 368, the original cover 3 is automatically opened, the surface of the contact glass is exposed to the outside, and the original cover 3 reaches the opening position. Accordingly, it is possible to place the original on the exposed surface of the contact glass 21.

When the lifted original cover 3 is manually pulled down (closed) after the original is placed on the surface of the contact glass 21, the original cover 3 is rotated in the closing direction, resulting that the original cover 3 rotates around the rotary shaft 46 in the direction in which it is in contact with the contact glass 21 (moves downward). When the original cover 3 is rotated in the closing direction as described above, at first, some force is required to resist the urging force of the compression spring 44a. However, for example, when the opening angle of the original cover 3 reaches 20° (including around 20°) or less, the moment of the original cover 3 becomes larger than the urging force that urges the original cover 3 using the compression spring 44a, so that it is possible to easily rotate the original cover 3. At this time, since the fluid damper device 144 is provided, when the opening angle of the original cover 3 reaches, for instance, 10° (including around 10°), the rotating speed of the original cover 3 is reduced by the fluid damper device 144, so that the original cover 3 does not collide with the contact glass 21 vigorously. Further, if the electromagnetic clutch 80 is driven when the rotating speed of the original cover 3 in the closing direction becomes fast, a rotation force of the pinion is transmitted to the pulse motor 361, and the detent torque or the like of the pulse motor 361 is applied as the friction load, resulting that the rotating speed of the original cover 3 is reduced. As a result, a chance in which the original cover 3 vigorously collides with the contact glass 21 is further reduced.

Besides, if the original 15 is thick such as a thick book, when the original cover 3 is rotated in the closing direction (moved downward), a part in the vicinity of the supporting member 42 of the original cover 3 is in contact with the end portion of the original on the supporting member 42 side or in the vicinity thereof, and a space is formed between the end portion at the opposite side from the end portion of the original on the supporting member 42 side and the original cover 3. Namely, the original cover 3 becomes in a floating state. When the floating original cover 3 is pressed toward the contact glass 21 side, the operation pin 49 presses the first slider 141 toward the second slider 142 side, the first slider 141 moves toward the second slider 142 side against the urging force of the compression spring 44a, and the original cover 3 rotates around the hinge pin 47. Specifically, the original cover 3 moves so as to cover the upper portion of the original. For example, when the upper portion of the original is a flat surface, the original cover 3 is in surface contact with the upper portion. Accordingly, the original having a large thickness is stably appressed against on the surface of the contact glass 21. The opening/closing operation can be conducted automatically, which is one of the characteristics of the present invention. Namely, when the pushing operation of the automatic close switch 26 for the original cover is performed after the original having a large thickness is placed on the contact glass, the pulse motor 361 rotates in the opposite direction to the opening direction of the original cover 3 to rotate the rotary arm 351, resulting that the original cover 3 can be closed. The reason why the operation and effect can be achieved is described above.

Further, to automatically close the original cover 3 at a normal time, the pushing operation of the automatic close switch 26 for the original cover is performed, for instance. When the automatic close switch 26 for the original cover is operated, the pulse motor 361 is rotary driven in the opposite direction to the opening direction. The rotary driving force of the pulse motor 361 is transmitted to the fourth gear 367 via the first to third gears 364, 365 and 366 to rotate the rotary arm 351 via the rotary shaft 368, the original cover 3 is automatically closed and is appressed against the surface of the contact glass. At this time, if the automatic rotary closing function possesses the low-speed function, the pulse motor 361 is controlled when the original cover 3 is positioned at an angle equal to or less than the predetermined opening angle and the rotating speed in the direction in which the original cover 3 is closed is reduced according thereto, resulting that the original cover 3 does not collide with the contact glass 21 vigorously.

As above, the original cover 3 is automatically opened/closed by the rotation of the rotary arm 351 attached at the forward side of the hinge part 4 of the original cover 3, in which a portion at which the force is acted on the original cover 3 when opening/closing the original cover 3 is distant from the hinge part 4, so that it is possible to open/close the original cover 3 with a small amount of force compared to a case in which the force is acted on the hinge part 4, for instance, the rotary shaft 46 to operate the original cover 3, resulting that the miniaturization of the driving part 5 can be realized. Accordingly, it becomes possible to realize the miniaturization of the third original cover closer 300 according to the present invention and the low cost.

Further, since the horizontal position control means 45 is provided in the lifting member 43, it is possible to adjust the position of the original cover 3 with respect to the contact glass 21, which makes it possible to appress the original against the contact glass 21 more stably.

Further, if a drive motor is the pulse motor 361, when a large torque different from a torque to rotate the original cover 3 is generated at the time of automatically rotating the original cover 3 in the opening direction or in the closing direction, the pulse motor 361 is stepped out, so that it is possible to prevent a damage of motors and the other parts such as the driving part 5.

As has been described above, the original cover closer according to the present invention can manually and automatically open/close the original cover, and the driving part is formed of the drive arm that supports either of left and right side portions of the original cover at the forward side of the hinge part of the main body, the driving force transmitting means that transmits the driving force to the drive arm, and the drive motor provided in the driving force transmitting means, so that it is possible to open/close the original cover with a small amount of force, and to realize not only the miniaturization of the driving part but also the low cost. Accordingly, the original cover closer according to the present invention can be suitably used as the original cover closer of, in particular, a copying machine, a printer, a facsimile machine, a scanner, and so on.

What is claimed is:

1. An original cover closer being a closer automatically and manually supporting an original cover in an openable/closable manner with respect to a main body of an office equipment, said original cover closer, comprising:
a hinge part; and
a driving part,
wherein said hinge part supports a rear portion of the original cover at a backward side of the main body and supports the original cover in an openable/closable manner with respect to the main body, and
wherein said driving part is formed of a drive arm that supports either or both left and right side portions of the original cover at a forward side of said hinge part of the main body, a driving force transmitting means that transmits a driving force to the drive arm, and a drive motor that applies the driving force to the driving force transmitting means.

2. The original cover closer according to claim 1,
wherein said hinge part is provided with a lift mechanism.

3. The original cover closer according to claim 1,
wherein the drive arm is a raising/lowering arm.

4. The original cover closer according to claim 3,
wherein the raising/lowering arm includes rack teeth engaging with a pinion attached to a drive case, and is structured to be sandwiched between a pair of guide members in a slidable manner in a state in which a movement thereof in the left and right directions of the main body when the main body is seen from the front, is controlled.

5. The original cover closer according to claim 4,
wherein the drive case is attached to the main body in a swingable manner in the raising/lowering direction of the raising/lowering arm.

6. The original cover closer according to claim 1,
wherein the drive arm is rotatably attached to a holding means whose one end portion is detachably attached to one side portion of the original cover.

7. The original cover closer according to claim 1,
wherein the drive arm is a rotary arm.

8. The original cover closer according to claim 7,
wherein one end portion of the rotary arm is slidably engaged with a guide groove formed in the original cover.

9. The original cover closer according to claim 1,
wherein the lift mechanism of said hinge part includes a lifting member that supports the original cover by being rotatably attached to a free end portion side of a supporting member rotatably attached to a mounting member attached to the main body side.

10. The original cover closer according to claim 1,
wherein the lift mechanism of said hinge part includes a leg portion attached to a mounting member attached on the main body so that it can move vertically with respect to the main body.

11. The original cover closer according to claim 1,
wherein the driving force transmitting means is provided with a clutch means that releases a connection between the driving force transmitting means and the drive arm when the original cover is operated manually.

12. The original cover closer according to claim 1,
wherein said driving part is placed on a stand which is provided separately from the main body.

13. The original cover closer according to claim 12,
wherein the stand is provided on a mounting plate which is fixed by mounting the main body thereon.

14. The original cover closer according to claim 1,
wherein the drive case to which the drive arm is attached is placed inside the main body, and the drive arm is structured to be protruded above the main body via a guide groove formed on the main body.

15. An office equipment, comprising
said original cover closer according to claim 1.
